(19) United States
(12) Patent Application Publication
(10) Pub. No.: US 2025/0214005 A1
(43) Pub. Date: Jul. 3, 2025

(54) WATER PUMP AND FILTER ASSEMBLY FOR WATER PUMP

(71) Applicant: ZHEJIANG ELE SMART TECHNOLOGY CO., LTD., Wenzhou (CN)

(72) Inventors: Shengyan Wang, Wenzhou (CN); Lingwei Shen, Wenzhou (CN)

(73) Assignee: ZHEJIANG ELE SMART TECHNOLOGY CO., LTD., Wenzhou (CN)

(21) Appl. No.: 18/969,020

(22) Filed: Dec. 4, 2024

(30) Foreign Application Priority Data
Dec. 28, 2023 (CN) 202311840782.5

(51) Int. Cl. B01D 29/56; B01D 29/01; B01D 29/05; B01D 35/26

(52) U.S. Cl. CPC B01D 29/56; B01D 29/014; B01D 29/055; B01D 35/26; B01D 2201/347

(57) ABSTRACT

A water pump and a filter assembly for the water pump. The water pump includes a water tank, a pump body with a water inlet located at the bottom of the water tank, and a filter assembly having a connecting opening, surrounding and connected to the water inlet of the pump body through the connecting opening, so that the water in the tank enters the pump body after being filtered by the filter assembly. The filter assembly is arranged in the water tank, and even if the filter assembly is clogged due to long-term use and ineffective cleaning, the water will not overflow from the water tank, thereby avoiding economic losses or safety hazards caused by water overflow. Further, the water pump and the filter assembly for the water pump have the advantages of simple structure, easy production and manufacturing, and economic benefits.

### BACKGROUND OF THE INVENTION

The present invention relates to the field of water filtration technology, and in particular to a water pump and a filter assembly for the water pump.

A water pump (for example, a condensate pump) may become clogged by debris after a period of use, causing reduced performance, or even technical problems such as foreign matter causing the impeller to be stuck or the motor to stall, which can cause fires.

To solve the above problems, some existing water pumps add a filter basket at the water inlet of the condensate pump to filter impurities in the water through the honeycomb holes on the filter basket. The drawback of this technology is that due to the small size of the filter basket, after a period of use, the impurities in the condensate will block the small holes of the filter basket, and the condensate will overflow from the mouth of the filter basket. The condensate cannot enter the water tank of the condensate pump, making the condensate pump ineffective. In addition, the overflowing condensate may soak the user's wooden floor or damage other objects, posing many hidden dangers.

Therefore, there is a need for a new water pump that solves the above problems.

### SUMMARY OF THE INVENTION

To solve at least some of the above problems, in a first aspect, the present invention provides a water pump which includes: a water tank; a pump body having a water inlet located at a bottom of the water tank; and a filter assembly having a connecting opening, wherein the filter assembly surrounds and is connected to the water inlet of the pump body through the connecting opening, wherein water in the water tank enters the pump body after being filtered by the filter assembly.

In some embodiments, the filter assembly includes a filter screen assembly of filter fabric.

In some embodiments, the filter assembly includes a filter screen assembly, which includes: a filter screen; a support frame configured to support the filter screen, where an outer edge of the support frame is connected to a bottom of the water tank, and an inner edge of the support frame is connected to the water inlet of the pump body; and a seal configured to seal a connection between the support frame and the pump body.

In some embodiments, the support frame includes a support portion, the filter screen is embedded in the support portion, and the support portion includes a plurality of through holes below the filter screen.

In some embodiments, the filter assembly is a first filter assembly, and the water pump further includes: a second filter assembly vertically installed in the water tank, located between a water tank inlet of the water tank and the first filter assembly, wherein the second filter assembly is configured to filter water entering the water tank and supplying the water to the first filter assembly for further filtering.

In some embodiments, the second filter assembly includes a fan-shaped filter screen which surrounds the water tank inlet of the water tank.

In some embodiments, the water tank includes multiple water tank inlets, and the second filter assembly includes multiple fan-shaped filter screens which respectively surround the multiple water tank inlets.

In some embodiments, the second filter assembly is connected to the bottom and side walls of the water tank, and a gap is reserved between the second filter assembly and the top of the water tank.

In some embodiments, the second filter assembly includes meshes of different hole sizes, and wherein the hole sizes of the meshes increase from a bottom to a top of the second filter assembly.

In some embodiments, the second filter assembly includes meshes of different densities, and wherein the densities of the meshes increase from the top to the bottom of the second filter assembly.

In some embodiments, the second filter assembly includes a plurality of vertical filter screens disposed between the water tank inlet of the water tank and the first filter assembly.

In some embodiments, the plurality of vertical filter screens have progressively decreasing heights from a filter screen farthest away from the pump body to a filter screen closest to the pump body, wherein a height of the filter screen closest to the pump body is not lower than a starting water level of the pump body.

In some embodiments, the second filter assembly is removably inserted into the water tank.

In some embodiments, the second filter assembly defines a filtering space between the second filter assembly and the water tank inlet of the water tank, and wherein the water pump further includes filter materials disposed in the filtering space, wherein diameters of the filter materials decrease from a top to a bottom of the water tank.

In a second aspect, the present invention provides a filter assembly for a water pump, the water pump including a water tank and a pump body having a water inlet located at a bottom of the water tank, the filter assembly including: a filter screen; a support frame configured to support the filter screen, where an outer edge of the support frame is connected to a bottom of the water tank, and an inner edge of the support frame is connected to the water inlet of the pump body; and a seal configured to seal a connection between the support frame and the pump body, wherein the filter assembly defines a connecting opening, the filter assembly surrounds and is connected to the water inlet of the pump body through the connecting opening, wherein water in the tank enters the pump body after being filtered by the filter assembly.

In embodiments of the present invention, the filter assembly is provided inside the water tank; even if the filter assembly is clogged due to long-term use and ineffective cleaning, water will not overflow the water tank, thereby avoiding economic losses or safety hazards caused by water overflow. Further, the water pump and the filter assembly for the water pump provided by the present invention have the advantages of simple structure, easy production and manufacturing, and economic benefits.

### BRIEF DESCRIPTION OF DRAWINGS

Preferred embodiments of the present invention are described with reference to the drawings. Other features and advantages of the present invention may be understood from the embodiments described below with reference to the drawings.

FIG. 1a shows a schematic structural diagram of a water pump according to a first embodiment of the present invention.

FIG. 1b is a schematic diagram showing a partial structure of the water pump of FIG. 1a.

FIG. 1c is a schematic structural diagram of a filter assembly in the water pump of FIG. 1a.

FIG. 2a shows a schematic structural diagram of a water pump according to a second embodiment of the present invention.

FIG. 2b is a schematic diagram showing a partial structure of the water pump of FIG. 2a.

FIG. 2c is a schematic structural diagram of a second filter assembly in the water pump of FIG. 2a.

FIG. 3a shows a schematic structural diagram of a water pump according to a third embodiment of the present invention.

FIG. 3b is a schematic structural diagram of a second filter assembly in the water pump of FIG. 3a.

FIG. 4 shows a schematic structural diagram of a water pump according to a fourth embodiment of the present invention.

### DETAILED DESCRIPTION OF THE INVENTION

Preferred embodiments of the present invention are described below with reference to the drawings. These drawings and descriptions explain embodiments of the invention but do not limit the invention. The described embodiments are not all possible embodiments of the present invention. Other embodiments are possible without departing from the spirit and scope of the invention, and the structure and/or logic of the illustrated embodiments may be modified. Thus, it is intended that the scope of the invention is defined by the appended claims.

Before describing the embodiments, some terms used in this disclosure are defined here to help the reader better understand this disclosure.

In the descriptions below, terms such as “one,” “one group,” etc. do not limit the number of components, but means at least one. In the descriptions below, terms such as “including” are intended to be open-ended and mean “including without limitation”, and can include other contents. “Based on” means “at least partly based on.” “An embodiment” means “at least one embodiment.” “Another embodiment” means “at least another embodiment,” etc. In this disclosure, the above terms do not necessarily refer to the same embodiments. Further, the various features, structures, materials or characteristics may be suitably combined in any of the one or more embodiments. Those of ordinary skill in the art may combine the various embodiments and various characteristics of the embodiments described herein when they are not contrary to each other.

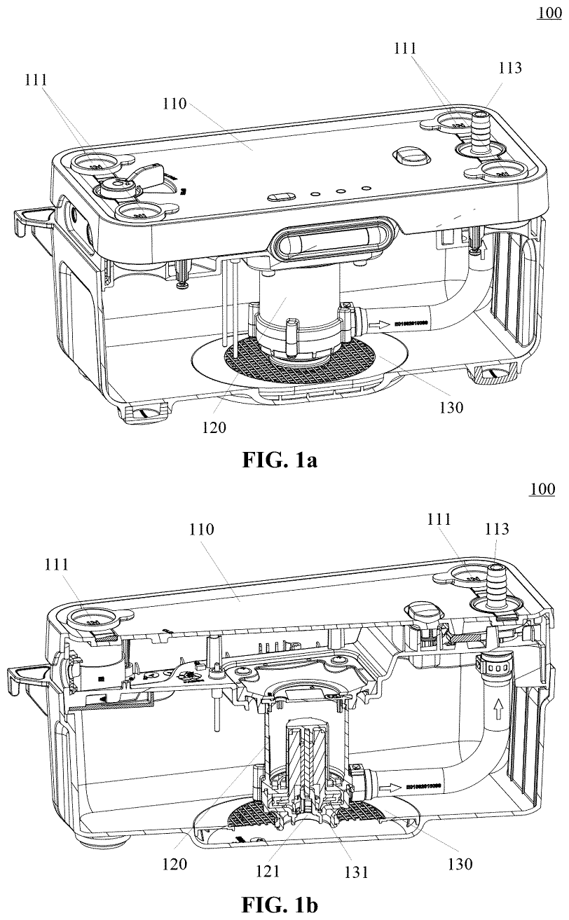

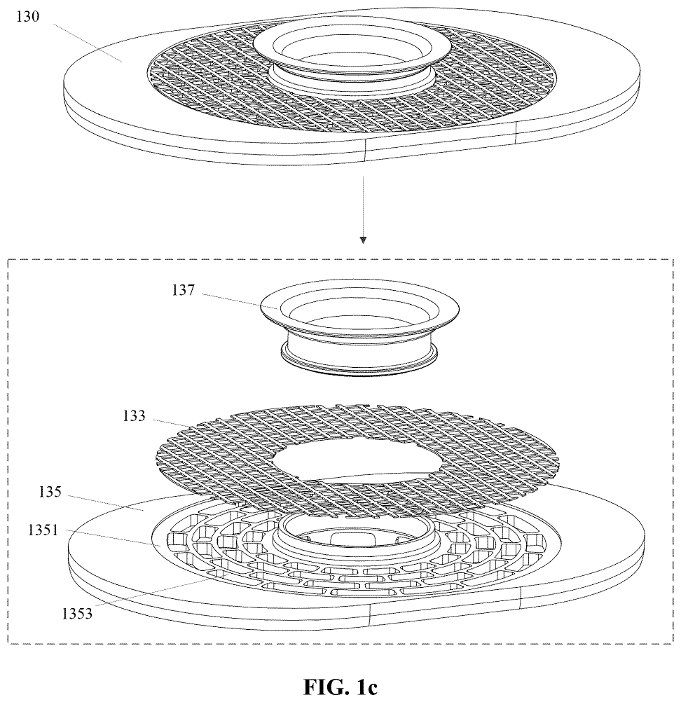

FIGS. 1a and 1b are schematic diagrams of the structure of a water pump 100 according to a first embodiment of the present invention. The water pump 100 includes a water tank 110, a pump body 120 and a filter assembly 130 (a first filter assembly, which is different from the second filter assembly described below). The water inlet 121 of the pump body 120 is located at the bottom of the water tank 110; a connecting opening 131 is provided on the filter assembly 130, and the filter assembly 130 is connected to and surrounds the water inlet 121 of the pump body 120 via the connecting opening 131, so that the water in the water tank 110 can enter the pump body 120 after being filtered by the filter assembly 130. The water pump 100 may be a condensate pump, a base pump, a submersible pump, a sewage pump, a delivery pump, a swimming pool pump or a jet pipe pump, etc.

The working principle of the water pump 100 is described as follows: after water enters through the water tank inlet 111 of the water tank 110, it is filtered through the filter assembly 130 under the action of gravity and/or the suction of the pump body 120, and then sent out through the water outlet 113 of the water tank under the action of the suction of the pump body 120.

FIG. 1c shows a schematic diagram of the structure of the filter assembly 130 in the water pump 100. The filter assembly 130 in this example is an assembly that includes a filter screen 133, a support frame 135 and a seal 137. The support frame 135 is configured to support the filter screen 133 which is horizontally disposed, where the outer edge of the support frame 135 is connected to the bottom of the water tank 110, and the inner edge of the support frame 135 is connected to the water inlet 121 of the pump body 120. The seal 137 is configured to seal the connection between the support frame 135 and the pump body 120. Preferably, the seal 137 is a flexible seal that can achieve the functions of shock absorption and sealing.

In other examples, the filter assembly 130 may use filter fabric, which has a connecting opening. The filter fabric surrounds the water inlet of the pump body through the connecting opening, and the water in the water tank is filtered by the filter fabric and then enters the pump body.

In some examples, the support frame 135 includes a support portion 1351, the filter screen 133 is embedded in the support portion 1351 of the support frame 135, and the support portion 1351 is provided with a plurality of through holes 1353 in the location below and corresponding to the filter screen 133 to provide a water flow path. The structural design of the support portion 1351 can effectively improve the support of the filter, prevent the filter from collapsing downward, and ensure structural stability and filtering effect. In some examples, the filter can be made of a nylon mesh. In some examples, the filter can be bonded or welded to the support frame.

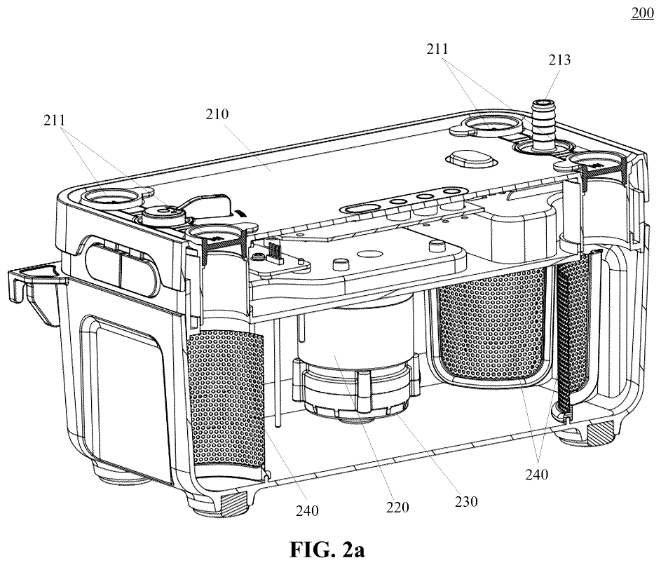

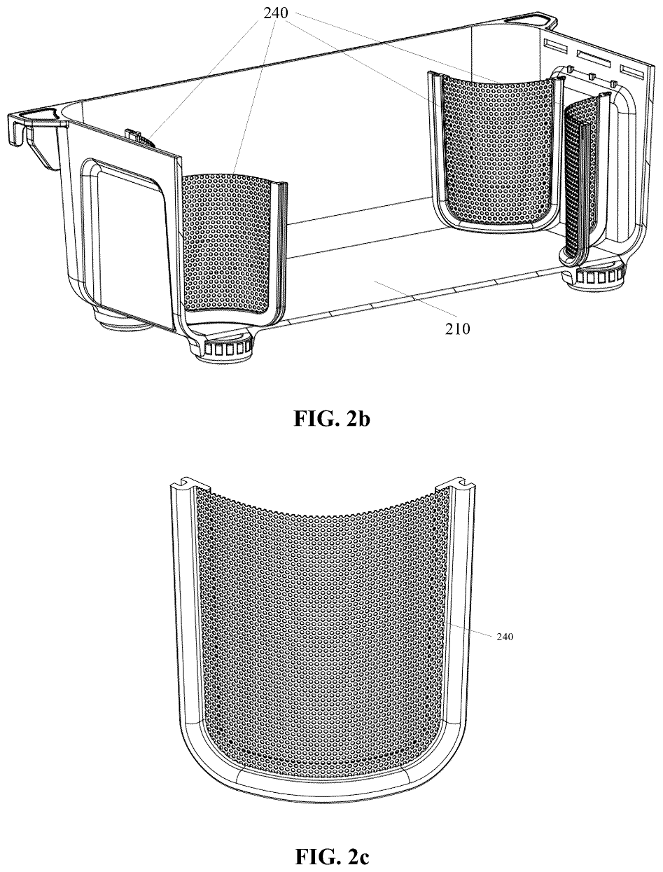

FIG. 2a shows a schematic diagram of the structure of a water pump 200 according to a second embodiment of the present invention. The water pump 200 includes a water tank 210, a pump body 220 and a first filter assembly 230. The structure of the water pump 200 is similar to that of the water pump 100, and descriptions of similar structures such as the water tank 210, the pump body 220 and the first filter assembly 230 are not repeated here. The water pump 200 in this embodiment also includes a second filter assembly 240, which is vertically installed in the water tank 210, located between the water tank inlet 211 of the water tank 210 and the first filter assembly 230, and is configured to filter the water entering the water tank through the second filter assembly 240 before supplying the water to the first filter assembly 230 for filtering. In some examples, the second filter assembly 240 may be a fan-shaped filter screen, which surrounds the water tank inlet 211 of the water tank 210. In some examples, the water tank 210 includes a plurality of water tank inlets 211, and the second filter assembly 240 includes a plurality of fan-shaped filter screens arranged in a one-to-one correspondence with the plurality of water tank inlets 211. For example, as shown in FIG. 2a, four water tank inlets are respectively provided at the four corners of the water tank 210. Correspondingly, the second filter assembly 240 includes four upright fan-shaped filter screens, which are respectively arranged around the four water tank inlets, to filter the water entering from the water tank inlets of the water tank.

FIG. 2b is a schematic diagram of a partial structure of the water pump 200. FIG. 2c is a schematic diagram of the structure of a fan-shaped filter screen. FIGS. 2b and 2c illustrate the connection, positional relationship and structure of the fan-shaped filter screen and the water tank. As shown in FIGS. 2b and 2c, the side wall and the bottom wall of the water tank 210 are provided with guide rails, and the side and bottom edges of the fan-shaped filter screen are provided with slots. The fan-shaped filter screen is connected to the water tank by detachably connecting the slots of the filter with the guide rails. This is convenient for users to disassemble, clean or replace the filter.

In some examples, a gap is reserved between the second filter assembly 240 and the top of the water tank 210, so that if the mesh of the second filter assembly is blocked by impurities, water can pass through the reserved gap, and then be filtered by the first filter assembly and discharged through the pump body, thereby ensuring the normal operation of the water pump and avoiding property losses or safety hazards that may be caused by water overflowing from the water tank.

In some examples, the mesh hole sizes of the second filter assembly 240 are of the same size. In other examples, the second filter assembly 240 is provided with meshes of different hole sizes, and the hole size of the meshes may gradually increase from the bottom to the top, so as to achieve classified filtration of impurities of different sizes.

In some examples, the meshes of the second filter assembly 240 are evenly distributed with the same density (number of hole per unit area). In other examples, the density of the meshes of the second filter assembly 240 increases gradually from top to bottom, so that when a denser area is clogged, water can flow through a less dense area.

In some examples, a filtering space is formed between the second filter assembly 240 and the water tank inlet of the water tank, and a plurality of filter materials of different diameters are arranged in the filtering space, and the diameter of the filter material gradually decreases from the top to the bottom. Such an arrangement can realize multi-step filtration of water and improve filtering effect.

The working principle of the water pump 200 is described as follows: After water enters the water tank 210 from the water tank inlet 211, it is first filtered by the fan-shaped filter assembly 240 corresponding to each water tank inlet. If the filter mesh of the fan-shaped filter screen is blocked, water flows through the gap reserved between the fan-shaped filter screen and the top of the water tank. After the water flows through the fan-shaped filter assembly 240, under the action of the suction force of the pump body 220, it can be filtered by the filter screen assembly 230 and enter the pump body, and then discharged through the water tank outlet 213.

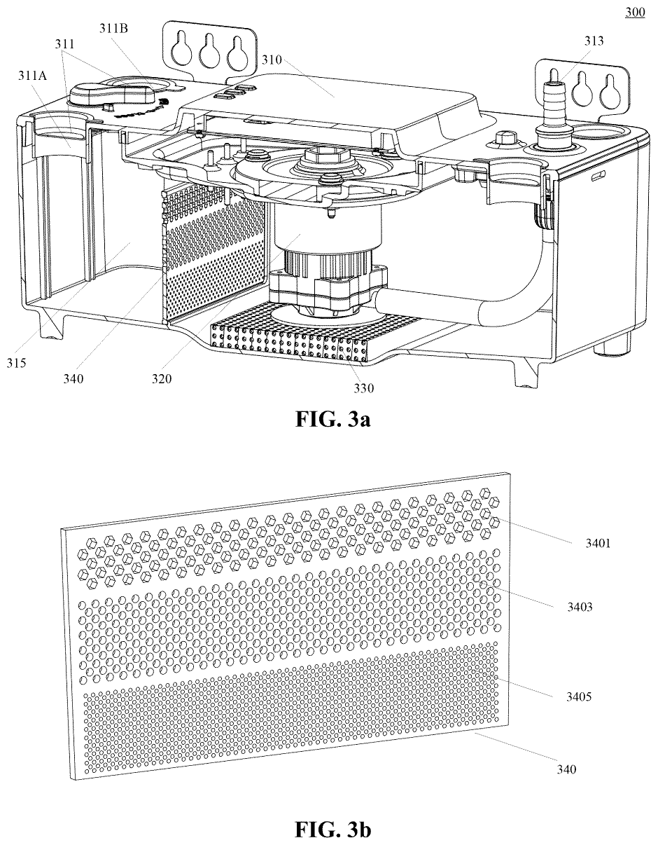

FIG. 3a shows a schematic diagram of the structure of a water pump 300 according to the third embodiment of the present invention. The water pump 300 includes a water tank 310, a pump body 320, a first filter assembly 330 and a second filter assembly 340. The water pump 300 is similar to the water pumps 100 and 200 described above, and descriptions of similar structures are not repeated here. The first filter assembly 330 in FIG. 3a uses filter fabric. It should be noted that the first filter assembly 330 of the water pump shown in FIG. 3a may also use the filter assembly described earlier. The second filter assembly 340 shown in FIG. 3a is a filter screen, which is vertically installed inside the water tank and is located between the water tank inlet on one side of the water tank and the water tank inlet of the pump body. It should be noted that the vertical filter screen in the figure is a rectangular filter screen, but its shape can be adaptively adjusted according to the internal structure of the water tank, and this embodiment does not limit this.

FIG. 3b is a schematic diagram of the structure of an exemplary second filter assembly 340. The second filter assembly 340 is a rectangular filter screen, which is provided with three different types of filter meshes 3401, 3403 and 3405 from top to bottom. Moreover, the mesh hole sizes of the three filter meshes 3401, 3403 and 3405 gradually decrease from top to bottom, and the density gradually increases.

The working principle of the water pump 300 is described as follows: After water enters the water tank from the water tank inlet 311 (including 311A and 311B), it is first filtered by the second filter assembly 340. If the filter mesh 3405 is blocked, the water can flow through the larger filter mesh 3403; if the filter mesh 3403 is also blocked, the water can flow through the larger filter mesh 3401; if the filter mesh 3401 is also blocked, the water flows through the reserved gap between the second filter assembly 340 and the top of the water tank. After the water flows through the second filter assembly 340, under the action of the suction of the pump body, it is filtered by the filter fabric 330 and enter the pump body, and then discharged through the water tank outlet 313.

The vertical filter screen 340 and the two side walls and bottom wall of the water tank 310 form a filtering space 315 at the water tank inlet 311A and 311B of the water tank. In some examples, filter material can be arranged in the filtering space 315 to further improve the filtering effect. In other examples, filter baffles can be arranged in the filtering space 315 to further improve the filtering effect. In some other examples, filter materials and filter baffles can be arranged in the filtering space 315 at the same time to further improve the filtering effect. Further, in some examples, a variety of different filter materials can be arranged in the filtering space 315. For example, filter balls of different diameters (for example, sponge balls and biochemical balls) can be used, and the diameter of the filter balls gradually decreases from top to bottom to achieve multi-step filtration.

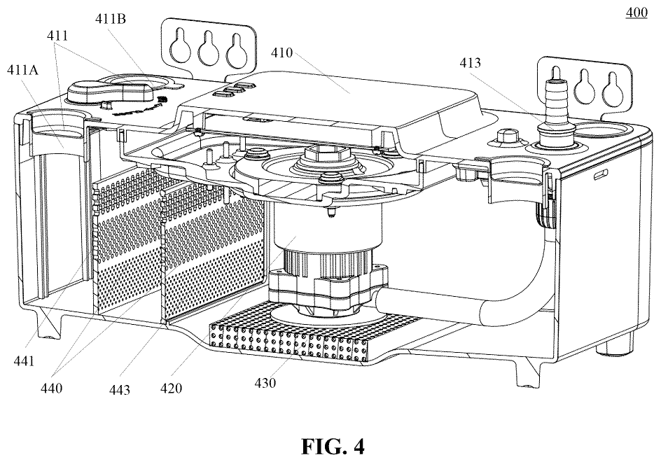

FIG. 4 shows a schematic diagram of the structure of a water pump 400 according to a fourth embodiment of the present invention. The water pump 400 includes a water tank 410, a pump body 420, a first filter assembly 430 and a second filter assembly 440. The structure of the water pump 400 is similar to that of the water pump 300, and descriptions of similar parts are not repeated here. One difference is that the second filter assembly 440 in the water pump 400 includes a plurality of vertical filter screens arranged between the water tank inlet 411 of the water tank 410 and the first filter assembly 430. Multi-layer filtration can be achieved through a plurality of vertical filter screens to improve the filtering effect. It should be noted that although the embodiment on FIG. 4 uses two vertical rectangular filter screens as an example, this embodiment does not limit the number and shape of the vertical filter screens.

Furthermore, in some examples, the top of the vertical filter screen closer to the pump body 420 is lower among the multiple vertical filter screens, and the top of the vertical filter screen closest to the pump body is not lower than the starting water level of the pump body (i.e. the water level at which the pump will start to pump water out of the water tank). This example can achieve the classified storage of filtered impurities by region, volume, and weight by setting different filtering spaces.

As shown in FIG. 4, the second filter assembly 440 includes a first vertical filter screen 441 and a second vertical filter screen 443, where the height of the first vertical filter screen 441 is greater than the height of the second vertical filter screen 443, that is, the reserved gap between the first vertical filter screen 441 and the top of the water tank is smaller than the reserved gap between the second vertical filter screen 443 and the top of the water tank.

The working principle of the water pump 400 is described as follows: After water enters the water tank from the water tank inlet 411 (including 411A and 411B), it is first filtered by the second filter assembly 440 (i.e., filtered by the first vertical filter screen 441 and the second vertical filter screen 443 in multiple steps). After the water flows through the second vertical filter screen 443, under the action of the suction force of the pump body, it can be filtered by the filter fabric 430 and then enter the pump body, and then discharged through the water tank outlet 413.

Embodiments of the present invention are described above. It will be apparent to those skilled in the art that various modifications may be made without departing from the spirit or scope of the invention. While the operation principles of the various embodiments are described, various structures, arrangements, proportions, devices, materials and components may be modified to adapt to particular environments or application requirements without departing from the spirit or scope of the invention. Such modifications of other modifications are within the scope of the present invention. Thus, the above descriptions do not limit the scope of the invention. While the advantages of various embodiments and the solutions to various technical problems are described, the advantages and solutions and any considerations that lead to these advantages or solutions, or other variations of solutions may not be critical, necessarily or inherent. Terms such as “include” or variations of such terms used in the above disclosure should be interpreted as being non-exclusive. The process, method, article of manufacture or apparatus that includes any listed elements may include not only these elements, but other elements not specifically listed or outside of these process, method, article of manufacture or apparatus. Further, terms such as “couple” or variations of such terms used in the above disclosure should be interpreted to include physical coupling, electrical coupling, magnetic coupling, optical coupling, communicative coupling, functional coupling and/or any other form of coupling.

It will be apparent to those skilled in the art that various modifications may be made to the above described embodiments without departing from the spirit or scope of the invention. Thus, it is intended that the scope of the invention is defined by the appended claims.

1. A water pump comprising:
a water tank;
a pump body having a water inlet located at a bottom of the water tank; and
a filter assembly having a connecting opening, wherein the filter assembly surrounds and is connected to the water inlet of the pump body through the connecting opening, wherein water in the water tank enters the pump body after being filtered by the filter assembly.

2. The water pump of claim 1, wherein the filter assembly includes a filter screen assembly of filter fabric.

3. The water pump of claim 1, wherein the filter assembly includes a filter screen assembly, which includes:
a filter screen;
a support frame configured to support the filter screen, where an outer edge of the support frame is connected to a bottom of the water tank, and an inner edge of the support frame is connected to the water inlet of the pump body; and
a seal configured to seal a connection between the support frame and the pump body.

4. The water pump of claim 3, wherein the support frame includes a support portion, the filter screen is embedded in the support portion, and the support portion includes a plurality of through holes below the filter screen.

5. The water pump of claim 1, wherein the filter assembly is a first filter assembly, the water pump further comprising:
a second filter assembly vertically installed in the water tank, located between a water tank inlet of the water tank and the first filter assembly, wherein the second filter assembly is configured to filter water entering the water tank and supplying the water to the first filter assembly for further filtering.

6. The water pump of claim 5, wherein the second filter assembly includes a fan-shaped filter screen which surrounds the water tank inlet of the water tank.

7. The water pump of claim 5, wherein the second filter assembly includes meshes of different hole sizes, and wherein the hole sizes of the meshes increase from a bottom to a top of the second filter assembly; or
the second filter assembly includes meshes of different densities, and wherein the densities of the meshes increase from the top to the bottom of the second filter assembly.

8. The water pump of claim 5, wherein the second filter assembly includes a plurality of vertical filter screens disposed between the water tank inlet of the water tank and the first filter assembly, wherein the plurality of vertical filter screens have progressively decreasing heights from a filter screen farthest away from the pump body to a filter screen closest to the pump body, wherein a height of the filter screen closest to the pump body is not lower than a starting water level of the pump body.

9. The water pump of claim 5, wherein the second filter assembly defines a filtering space between the second filter assembly and the water tank inlet of the water tank, and wherein the water pump further includes filter materials disposed in the filtering space, wherein diameters of the filter materials decrease from a top to a bottom of the water tank.

10. A filter assembly for a water pump, the water pump comprising a water tank and a pump body having a water inlet located at a bottom of the water tank, the filter assembly comprising:
a filter screen;
a support frame configured to support the filter screen, where an outer edge of the support frame is connected to a bottom of the water tank, and an inner edge of the support frame is connected to the water inlet of the pump body; and
a seal configured to seal a connection between the support frame and the pump body,
wherein the filter assembly defines a connecting opening, the filter assembly surrounds and is connected to the water inlet of the pump body through the connecting opening, wherein water in the tank enters the pump body after being filtered by the filter assembly.
